(19) United States
(12) Patent Application Publication
(10) Pub. No.: US 2005/0074575 A1
(43) Pub. Date: Apr. 7, 2005

(54) Vacuum packaging film, method of manufacturing the same and vacuum packaging bag using the same

(76) Inventor: Wan Hyuk Yoon, Incheon-shi (KR)

Correspondence Address: STAAS & HALSEY LLP, SUITE 700, 1201 NEW YORK AVENUE, N.W., WASHINGTON, DC, 20005, US

(21) Appl. No.: 10/674,479

(22) Filed: Oct. 1, 2003

(51) Int. Cl. D01D 1/00; C06B 21/00; B32B 3/26; B32B 3/02; B32B 27/00; B32B 27/40

(52) U.S. Cl. 428/63; 428/424.2; 428/66.5; 264/3.3

(57) ABSTRACT

Disclosed is a vacuum packaging film having a multiple of groups of protuberances, a method of manufacturing the same and a vacuum packaging bag using the same. The vacuum packaging film includes a base layer, and a thermoforming layer laminated on the base layer and having protuberances on an inner surface thereof to form air passages, in which the protuberances have first group of protuberances, second group of protuberances having a height higher than that of the first group of protuberances, third group of protuberances having a height higher than that of the second group of protuberances, and fourth group of protuberances having a height higher than that of the third group of protuberances. Further, the four groups of protuberances have different arrangements arranged at different angles, thus clearly showing a pattern formed on an inner surface of the thermoforming layer. Also, since the vacuum packaging film has two to four groups of protuberances, a total surface area of the protuberances is enlarged. Thereby, an output flux of air increases and an internal chamber of the vacuum packaging bag can be easily made to the state of vacuum. Furthermore, a variety of patterns can be formed by various sizes and different arrangement directions of the protuberances, therefore resulting in increased productivity of end products according the needs of users.

### BACKGROUND OF THE INVENTION

1. Field of the Invention

The present invention relates, in general, to vacuum packaging films having a multiple of groups of protuberances, and manufacturing methods thereof and vacuum packaging bags using the same. More specifically, the present invention is directed to a vacuum packaging film, a method of manufacturing the same, and a vacuum packaging bag using the same, characterized in that two to four groups of protuberances are formed on at least one of its facing inner surfaces of the vacuum packaging bag, whereby a total surface area of the protuberances becomes wider and an output flux of air increases, and, as well, various sizes and shapes and irregular arrangements of the protuberances afford various patterns.

2. Description of the Related Art

In various countries including the United States, methods of storing foods, such as meats or processed meats, for long periods have been employed, including the steps of receiving such foods into a plastic bag in which the state of vacuum may be maintained to prevent contamination and/or oxidization by air, and subjecting the bag to a vacuum treatment by use of an air pump or other vacuum units (generally called vacuum Sealer), followed by sealing an inlet of the bag.

With reference to FIG. 1, there is shown a conventional vacuum packaging bag 500, including an upper sheet 200 and a lower sheet 300 each having both surfaces made of a plastic material. Furthermore, to form an internal chamber receiving contents like foodstuffs to be stored, both side edges and lower edges of the upper sheet 200 and the lower sheet 300 are thermally sealed to form a sealed part S. Furthermore, to evacuate inner-air of the bag 500 after the contents are received into the internal chamber of the bag 500, upper edges of the upper sheet 200 and the lower sheet 300 are open to form an open part 400. The inner surfaces of the vacuum packaging bag 500 are made of a thermoplastic resin, such as polyethylene, capable of being melted while being non-toxic to humans, and the outer surfaces of the vacuum packaging bag 500 include a multi-layered structure formed of high barrier material, such as nylon, for storage of long periods after the vacuum packaging.

The storing contents are received into the vacuum packaging bag 500 through the open part 400 of the vacuum packaging bag 500, after inner-air in the bag 500 is evacuated by use of an air sealer or other vacuum units, whereby the internal chamber of the vacuum packaging bag 500 gets to the state of vacuum. Then, the open part 400 is heated to be higher than predetermined temperatures, and compressed and sealed. However, in cases where the bag 500 is sealed by use of the vacuum sealer, while inner-air of the upper portion of the bag 500, present near the vacuum sealer, is suddenly sucked, the upper sheet 200 and the lower sheet 300 constituting the bag 500 are mutually sealed (this is called ‘early collapse’). Thus, the complete vacuum state of the internal chamber of the bag 500 cannot be achieved due to residual air of the lower portion of the bag 500, and it is difficult to store the contents.

To prevent such early collapse, techniques for forming an air passage by subjecting the film made of a thermoplastic material to an embossing treatment have been developed. In this regard, the film having air passages is disclosed in U.S. Pat. No. 2,778,171 (G. Taunton, 1957) and U.S. Pat. No. 3,255,567 (L. D. Keslar Etal, 1966) and U.S. Pat. No. 3,311,517 (L. D. Keslar Etal, 1967) and Japanese Patent No. S 56-13362 (1979).

The known techniques disclose air passages 26 formed only by protuberances 22 having regular heights, intervals and shapes, as shown in FIG. 2. However, by means of thusly formed air passages, a vacuum performance becomes inferior, and thus it is difficult to almost impossible to realize various patterns. Furthermore, there are caused problems concerning transcribing patterns to surfaces of the sheets 200 and 300 or embossing surfaces of the sheets 200 and 300, according to various needs of the consumers.

As such, the vacuum performances depend on the heights, shapes, arrangements and structure and total floor of the protuberances. As for the heights of the protuberances, when higher protuberances are used, there is no phenomenon of the so-called ‘early collapse’ caused by powerful and sudden outward suction force of air. In addition, since the protuberances are formed to aid the natural evacuation of inner-air in the bag, they are preferably arranged so that respective air passages are linearly connected to the open part of the bag. Also, an outward flux of inner-air per unit time is proportional to the total surface area of the protuberances. Thus, as the total surface area of the protuberances is wider, the evacuation rate of the inner-air becomes faster.

### SUMMARY OF THE INVENTION

Accordingly, an aspect of the present invention is to alleviate the problems encountered in the related prior art and to provide a vacuum packaging film, characterized by having an enlarged total surface area of protuberances, so that an early collapse does not occur upon evacuating the inner air by use of a vacuum unit, thereby improving a vacuum performance.

Another aspect of the present invention is to provide a vacuum packaging film, characterized in that two to four groups of protuberances are arranged in different directions, thereby realizing various patterns, and functioning to increase productivity of a vacuum packaging bag according to a variety of needs of the users.

A still another aspect of the present invention is to provide a vacuum packaging bag using the vacuum packaging film.

A further aspect of the present invention is to provide a method of manufacturing the vacuum packaging film.

To achieve the above aspects of the present invention, there is provided a vacuum packaging film having two to four groups of protuberances, including a base layer, and a thermoforming layer laminated on the base layer and having protuberances on an inner surface of the thermoforming to form air passages, wherein the protuberances have first group of protuberances, and second group of protuberances having a height higher than that of the first group of protuberances.

As for the vacuum packaging film, the first group of protuberances and the second group of protuberances have different arrangements arranged at different angles, to clearly show a pattern formed on the inner surface of the thermoforming layer.

As for the vacuum packaging film, the first group of protuberances and the second group of protuberances have various sizes.

As for the vacuum packaging film, the first group of protuberances and the second group of protuberances have different shapes.

As for the vacuum packaging film, the patterns comprise the shapes of fruits, animals, plants and diagrams.

As for the vacuum packaging film, the first group of protuberances each are 0.8-1.5 times thicker than a thickness of the thermoforming layer.

As for the vacuum packaging film, the second group of protuberances each are 1.0-2.0 times thicker than a thickness of the thermoforming layer.

The vacuum packaging film further comprises an adhesive layer between the base layer and the thermoforming layer.

As for the vacuum packaging film, the base layer comprises polyamide, polyester, or ethylene vinyl alcohol.

As for the vacuum packaging film, the base layer comprises a multi-layered structure including at least one layer.

As for the vacuum packaging film, the thermoforming layer comprises polyethylene.

As for the vacuum packaging film, a surface of the thermoforming layer comprises a flat part which is not embossed, first group of protuberances, and second group of protuberances.

As for the vacuum packaging film, a surface of the thermoforming layer comprises first group of protuberances and second group of protuberances.

As for the vacuum packaging film, the protuberances further comprise third group of protuberances having a height higher than that of the second group of protuberances.

As for the vacuum packaging film, the protuberances further comprise fourth group of protuberances having a height higher than that of the third group of protuberances.

As for the vacuum packaging film, the first group of protuberances, the second group of protuberances and the third group of protuberances have different arrangements arranged at different angles, to clearly show a pattern formed on the inner surface of the thermoforming layer.

As for the vacuum packaging film, the first group of protuberances, the second group of protuberances and the third group of protuberances have various sizes.

As for the vacuum packaging film, the first group of protuberances, the second group of protuberances and the third group of protuberances have different shapes

As for the vacuum packaging film, the first group of protuberances, the second group of protuberances, the third group of protuberances and the fourth group of protuberances have different arrangements arranged at different angles, to clearly show a pattern formed on the inner surface of the thermoforming layer.

As for the vacuum packaging film, the first group of protuberances, the second group of protuberances, the third group of protuberances and the fourth group of protuberances have various sizes.

As for the vacuum packaging film, the first group of protuberances, the second group of protuberances, the third group of protuberances and the fourth group of protuberances have different shapes.

As for the vacuum packaging film, a layer printed with a pattern identical to that formed on the inner surface of the thermoforming layer is transcribed to an outer surface of the thermoforming layer.

In addition, there is provided a vacuum packaging bag, including an upper sheet and a lower sheet superimposed mutually, in which lower edges and both side edges of the upper sheet and the lower sheet are sealed to form an internal chamber of the vacuum packaging bag, and upper edges of the upper sheet and the lower sheet are open to form an open part to receive contents into the vacuum packaging bag, and at least one of the upper sheet and the lower sheet includes the vacuum packaging film as mentioned above.

Furthermore, there is provided a method of manufacturing a vacuum packaging film, including the following steps of melt-extruding a thermoforming layer on a base layer made of an gas-impermeable material through a nozzle of a T-die extruder, to prepare a film, and passing the film through a layering unit with a embossed roll having embossments and a water cooling roll, wherein the embossed roll of the layering unit has first group of embossments and second group of embossments, and thus the thermoforming layer has first group of protuberances and second group of protuberances on an inner surface thereof, corresponding to each position of the first group of embossments and the second group of embossments of the embossed roll, to form air passages.

Furthermore, there is provided a method of manufacturing a vacuum packaging film, including the following steps of passing a thermoforming layer through a protuberance-forming unit with a embossed roll having embossments and a flat roll, to form protuberances on an inner surface of the thermoforming layer, and passing a base layer made of an air-impermeable material and the thermoforming layer with protuberances through a layering unit with two layering rolls, wherein the embossed roll of the protuberance-forming unit has first group of embossments and second group of embossments, whereby the thermoforming layer passed through the protuberance-forming unit has first group of protuberances and second group of protuberances on an inner surface of the thermoforming layer, corresponding to each position of the first group of embossments and the second group of each embossments of the embossed roll, to form air passages.

As for the method, the first group of embossments and the second group of embossments of the embossed roll have different arrangements arranged at different angles, to clearly show a pattern formed on the inner surface of the thermoforming layer.

As for the method, the first group of embossments and the second group of embossments of the embossed roll have various sizes.

As for the method, the first group of embossments and the second group of embossments of the embossed roll have different shapes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a conventional vacuum packaging bag;

FIG. 2 is a perspective view of another conventional vacuum packaging bag;

FIG. 3 is a perspective view of a vacuum packaging bag using a vacuum packaging film of the present invention;

FIG. 4 is a perspective view of a vacuum packaging film, according to a first embodiment of the present invention;

FIG. 5 is an exploded view of a part of the vacuum packaging film shown in FIG. 4;

FIG. 6 is a perspective view of a vacuum packaging film, according to a second embodiment of the present invention;

FIG. 7 is an exploded view of a part of the vacuum packaging film shown in FIG. 6;

FIGS. 8a to 8q are bottom views of various patterns formed on an inner surface of the vacuum packaging film of the present invention;

FIG. 9 is a view to show a process of manufacturing the vacuum packaging film having two groups of protuberances, according to an embodiment of the present invention; and

FIG. 10 is a view to show a process of manufacturing the vacuum packaging film having two groups of protuberances, according to another embodiment of the present invention.

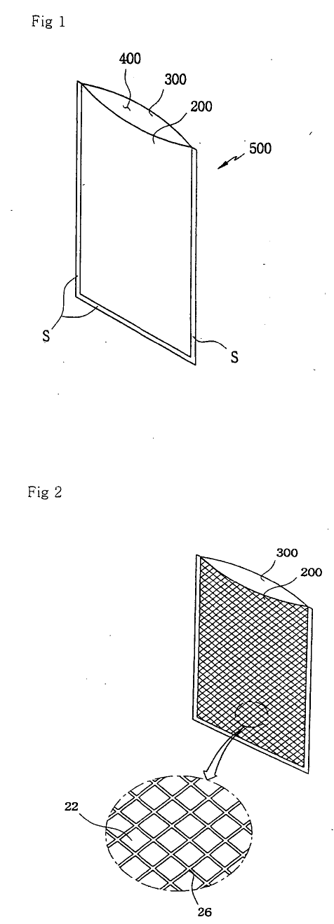

### DETAILED DESCRIPTION OF THE INVENTION

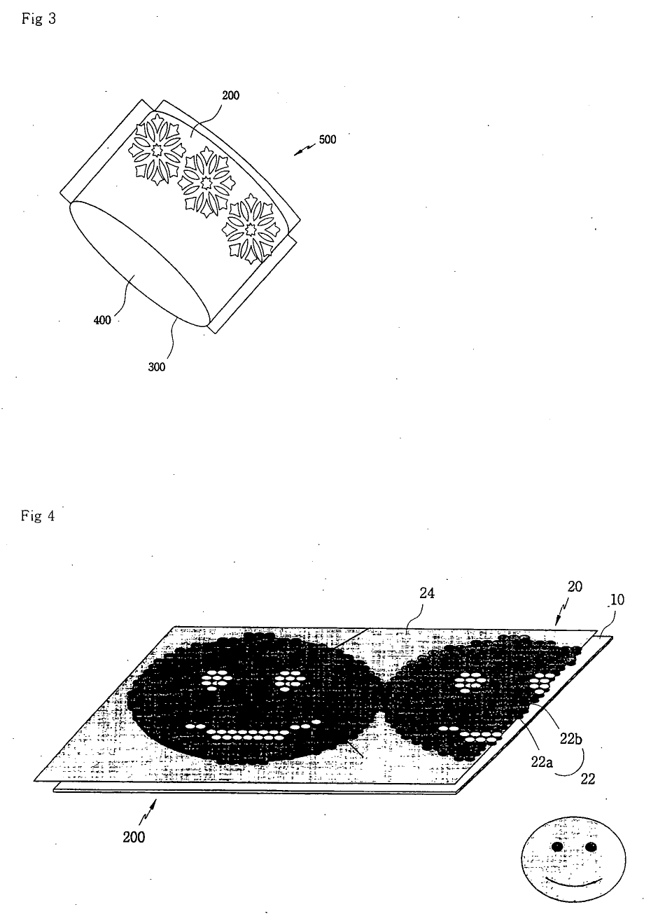

Referring to FIG. 3, there is a perspective view of a vacuum packaging bag using a packaging film of the present invention. The vacuum packaging bag 500 includes an upper sheet 200, and a lower sheet 300 having a size corresponding to that of the upper sheet 200. In addition, lower edges and both side edges of the upper sheet 200 and the lower sheet 300 are sealed to form an internal chamber of the vacuum packaging bag 500, and upper edges of the upper sheet 200 and the lower sheet 300 are open to form an open part 400, which is used to receive contents into the vacuum packaging bag 500.

The lower sheet 300 of the vacuum packaging bag 500 includes two or more layers, and preferably, five layers, of polyamide and polyethylene layered alternately.

The lower sheet 300 having five layers has a thickness of 60-100 m, in which polyamide for use in blocking gas is at least more than 20 m thick, and polyethylene is 40-50 m thick.

FIG. 4 is a perspective view of a vacuum packaging film (upper sheet), according to a first embodiment of the present invention. A surface of a thermoforming layer 20 of the packaging film includes a flat part 24 which is not subjected to an embossing treatment, first group of protuberances 22a and second group of protuberances 22b.

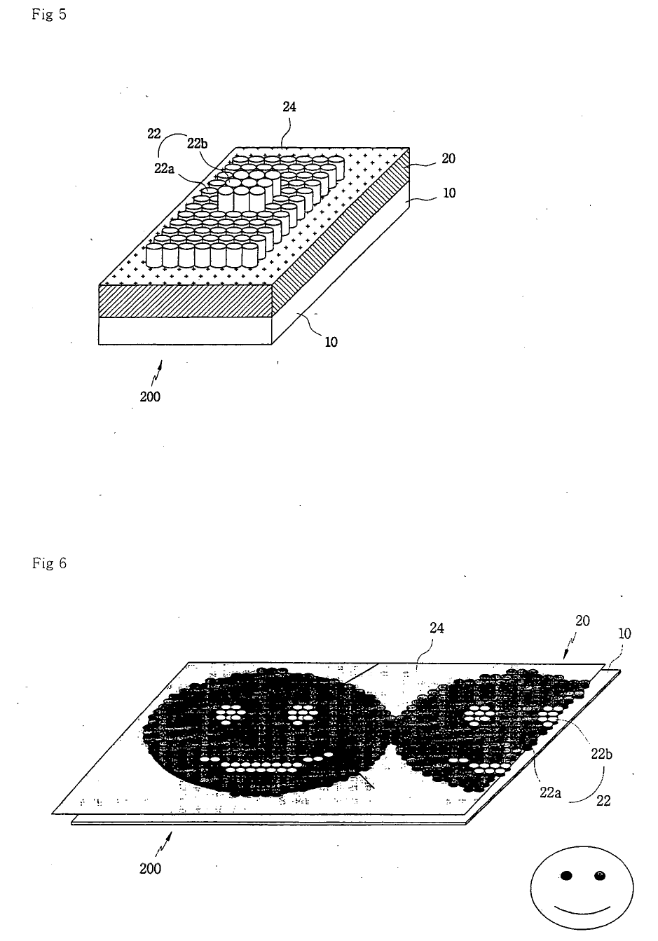

FIG. 5 is an exploded view of a part of the vacuum packaging film shown in FIG. 4. On the surface of the upper sheet 200 having two layers, a plurality of the first group of protuberances 22a being 60 m high with a cylindrical shape are formed. Also, second group of protuberances 22b being 80 m high are bundled at a central portion of the first group of protuberances, to form a total pattern shape resembling that of human eyes.

Although the protuberances 22 having predetermined sizes with a cylindrical shape are shown in FIG. 5, they are not limited thereto and may include various shapes, such as rectangles or octagons, and various sizes.

The upper sheet 200 of the vacuum packaging bag 500 includes a base layer 10 and a thermoforming layer 20 laminated on the base layer 10.

The upper sheet 200 is layered by means of a dry-laminating process or a T-die process. According to the dry-laminating process, an adhesive layer is inserted into the base layer 10 and the thermoforming layer 20.

The adhesive layer is preferably made of polyethylene.

According to the T-die process, the upper sheet 200 includes two layers, which are a base layer 10 and a thermoforming layer 20 laminated on the base layer 10. The base layer 10 is 20 m thick, and the thermoforming layer 20 is 40-60 m thick. Thus, the upper sheet 200 having the thickness not less than 60 m can be manufactured.

The base layer 10 is preferably made of polyamide, polyester, or ethylene vinyl alcohol (EVOH). More preferably, the base layer 10 is made of polyamide.

The thermoforming layer 20 is made of polyethylene. This is because the protuberances 22 can be easily formed on the inner surface of the resin layer 20 made of polyethylene as a thermoplastic resin.

In the present invention, the protuberances 22 are formed only on the upper sheet 200. However, the protuberances 22 may be formed on an inner surface of the lower sheet 300.

When the surface of the thermoforming layer 20 includes the flat part 24 without embossments, the first group of protuberances 22a and the second group of protuberances 22b, the shape of the mouth or eyes of the smiling face shown in FIG. 4 or 5 is not distinctly viewed. However, a total surface area of the protuberances 22 is enlarged, thus improving the vacuum speed and vacuum performance.

FIG. 6 is a perspective view of a vacuum packaging film, according to a second embodiment of the present invention, in which a surface of a thermoforming layer 20 of the vacuum packaging film includes only first group of protuberances 22a and second group of protuberances 22b.

As shown in FIG. 6, the shapes of smiling faces of humans are formed on the surface of the thermoforming layer 20. The second group of protuberances 22b are responsible for the total shapes of smiling faces of humans, and the first group of protuberances 22a are formed on the portions of the eye and mouth and the portion outside the smiling face at heights lower than those of the second group of protuberances 22b. Thereby, the shape of the smiling face is realized.

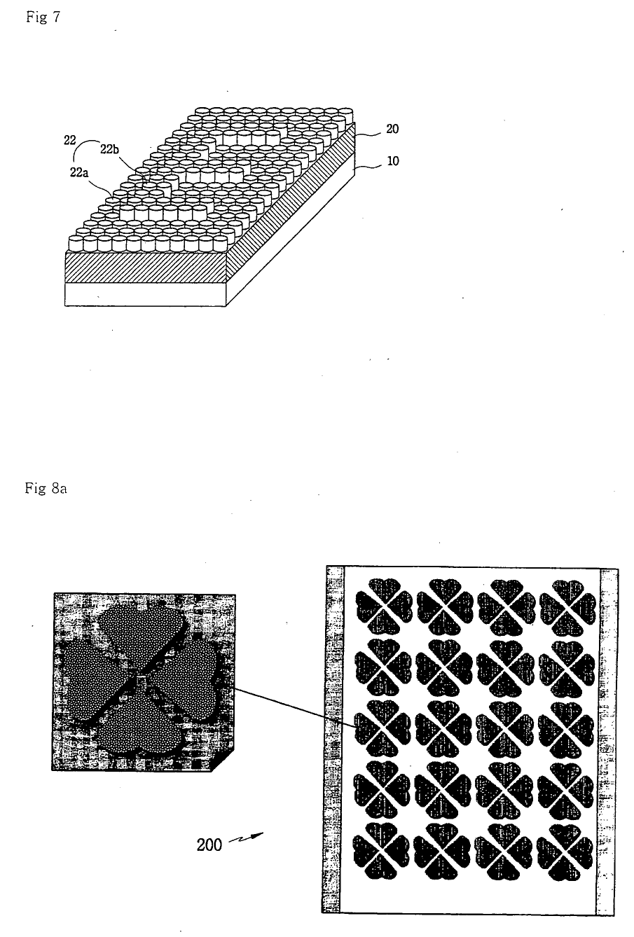

FIG. 7 is an exploded view of a part of the vacuum packaging film shown in FIG. 6. On the surface of an upper sheet 200 including two layers, a plurality of first group of protuberances 22a are formed as 50 m high cylinders, and a plurality of second group of protuberances 22b being 80 m high are formed. In such a case, the portion formed with the second group of protuberances 22b is shown as embossments, and the portion formed with the first group of protuberances 22a is relatively shown as depressions.

When the surface of the thermoforming layer 20 is formed with only the first group of protuberances 22a and the second group of protuberances 22b, the total surface area of the protuberances 22 increases, thus increasing the vacuum speed and vacuum performance. However, more than two-dimensional protuberances could be adopted preferably in order to embody the patterns more distinctively and to enhance the vacuum performance, though only the first group of protuberances 22a and the second group of protuberances 22b are shown in FIG. 6 and FIG. 7. As well, various designs may be applied and pattern outlines are further distinct.

In addition, the first group of protuberances 22a and the second group of protuberances 22b are arranged in different directions, whereby a variety of patterns can be formed, thus increasing productivity of end products while satisfying various needs of the users.

Although conventional arrangements of the protuberances 22 are regularly patterned and various patterns cannot be reliably formed on the upper sheet 200, the protuberances 22 are irregularly arranged in the present invention, thereby realizing various designs. This distinctive feature can be enhanced more with application of various shapes as well as various sizes of the two groups of protuberances.

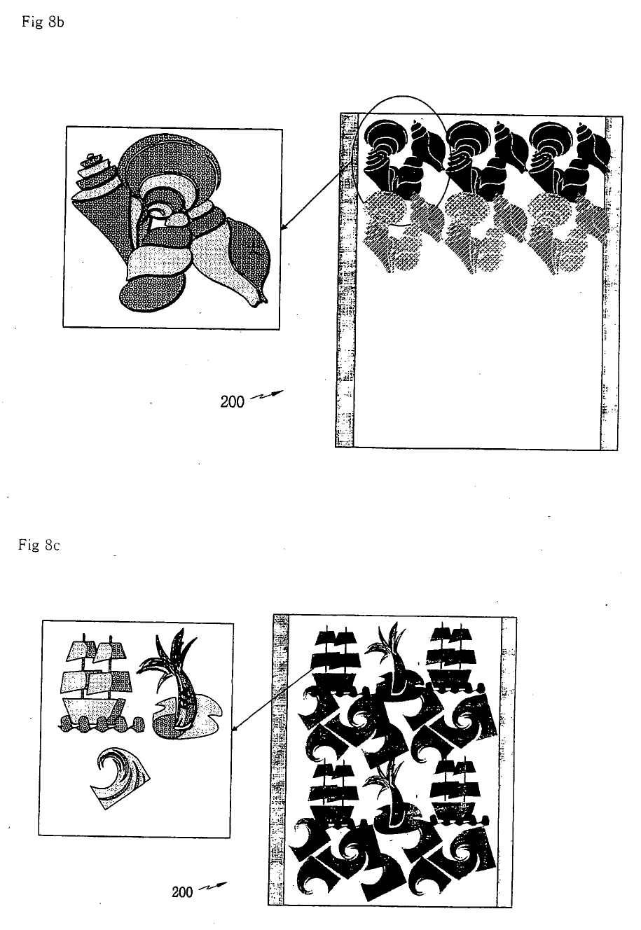

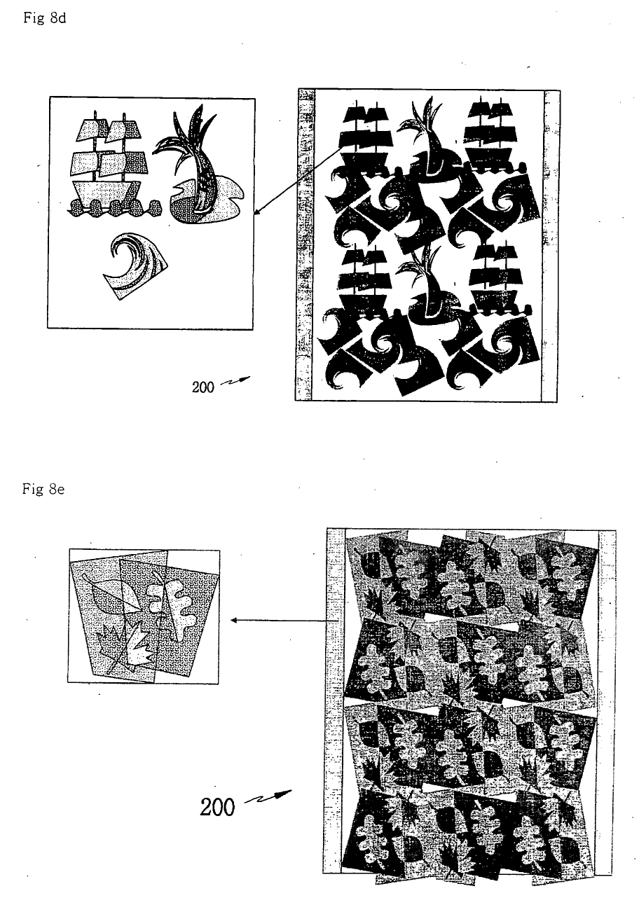

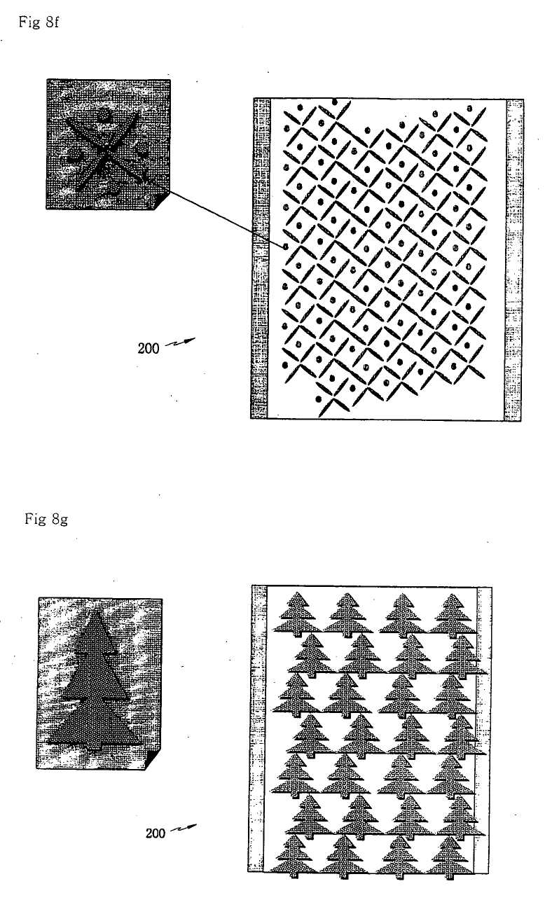

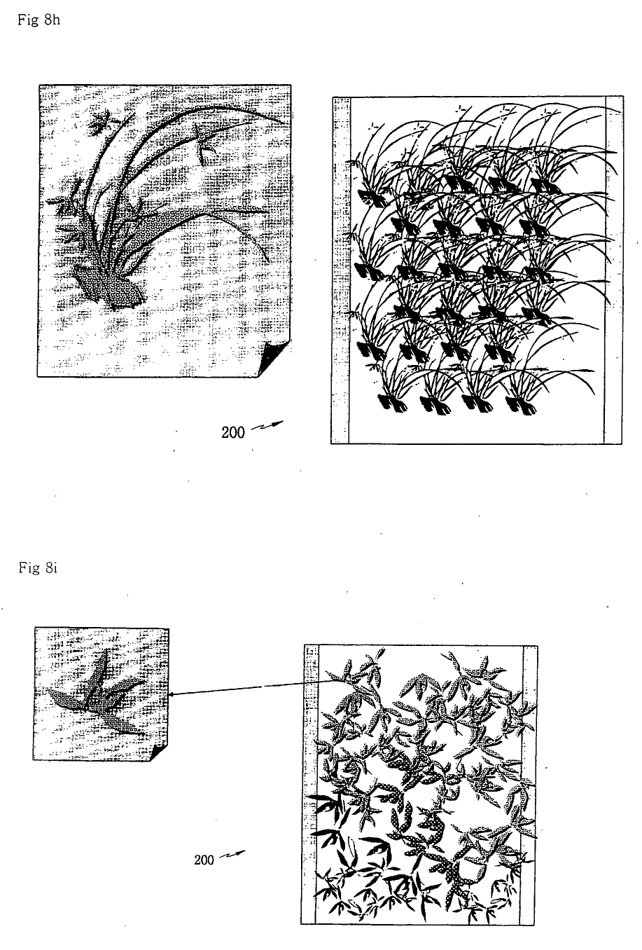

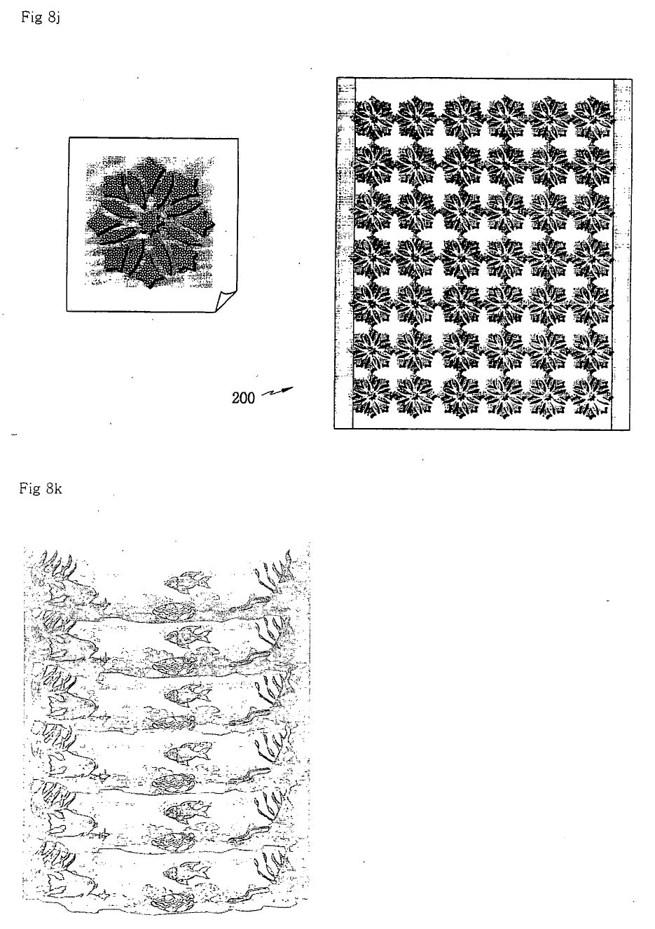

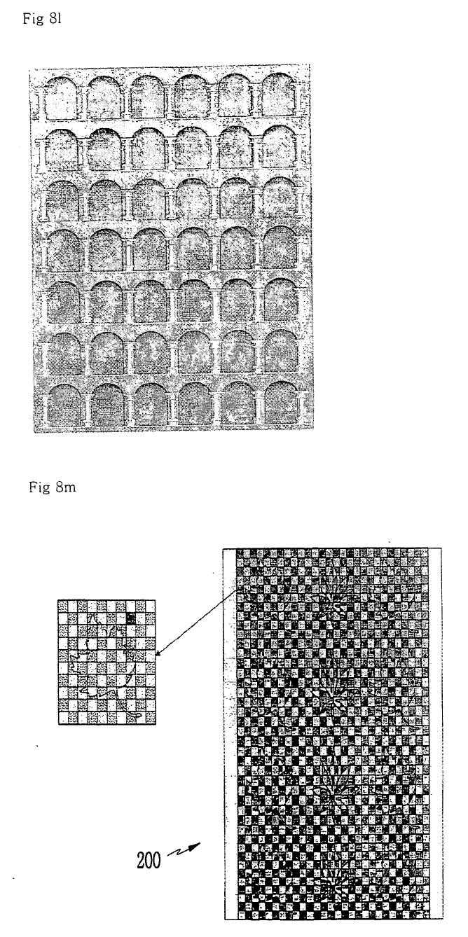

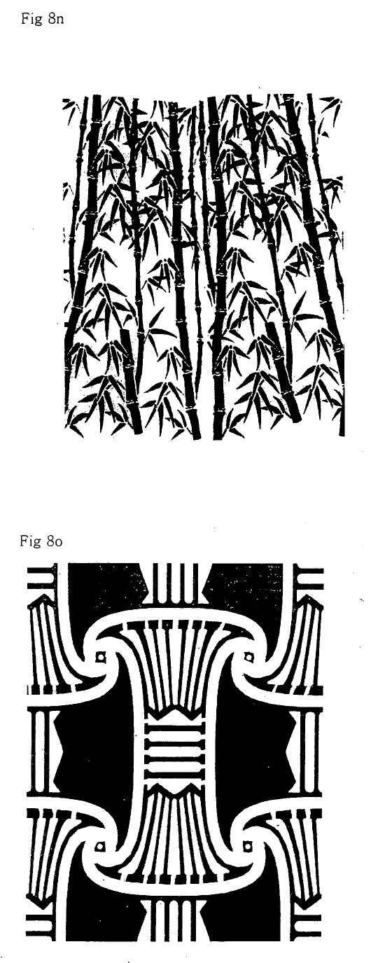

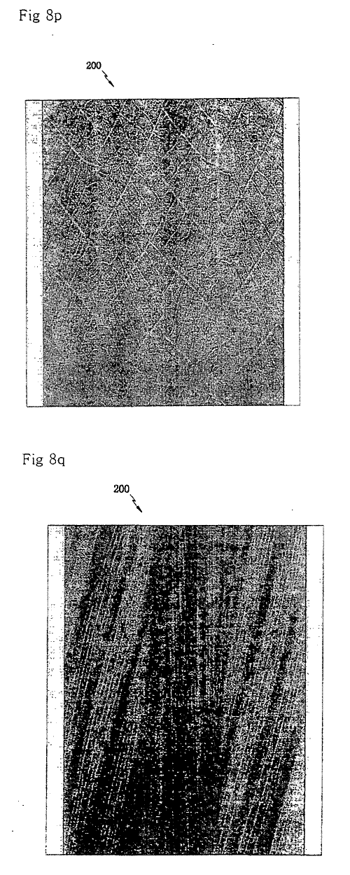

FIGS. 8a to 8m show various patterns by two groups of protuberances formed on the upper sheet 200, in which the two groups of protuberances have irregular arrangements, are arranged in different directions

FIG. 8a shows the shape of clovers patterned on an inner surface of a thermoforming layer of the upper sheet, and FIG. 8b shows the shape of conchs patterned on an inner surface of a thermoforming layer of the upper sheet. FIG. 8c shows the shape of ships patterned on an inner surface of a thermoforming layer of the upper sheet, and FIG. 8d shows the shape of leaves patterned on an inner surface of a thermoforming layer of the upper sheet. Further, FIG. 8e shows the shape of flowers patterned on an inner surface of a thermoforming layer of the upper sheet, and FIG. 8f shows the shape of cosmos patterned on an inner surface of a thermoforming layer of the upper sheet. In addition, FIG. 8g shows the shape of Christmas trees patterned on an inner surface of a thermoforming layer of the upper sheet, and FIG. 8h shows the shape of orchids patterned on an inner surface of a thermoforming layer of the upper sheet. Also, FIG. 8i shows the shape of petals patterned on an inner surface of a thermoforming layer of the upper sheet, and FIG. 8j shows the shape of turf patterned on an inner surface of a thermoforming layer of the upper sheet. FIG. 8k shows the shape of fish and marine plants patterned on an inner surface of a thermoforming layer of the upper sheet, and FIG. 81 shows the shape of a plurality of doors patterned on an inner surface of a thermoforming layer of the upper sheet. FIG. 8m shows the shape of autumnal leaves patterned on an inner surface of a thermoforming layer of the upper sheet.

As shown in FIGS. 8a to 8m, various patterns may be realized by the flat part which is not subjected to an embossing treatment, the first group of protuberances and the second group of protuberances.

In addition. FIG. 8n shows the shape of bamboo patterned on an inner surface of a thermoforming layer of the upper sheet, and FIG. 80 shows the shape of ancient characters patterned on an inner surface of a thermoforming layer of the upper sheet. FIGS. 8p and 8q show the shape of leaf textures patterned on an inner surface of a thermoforming layer of the upper sheet.

As shown in FIGS. 8n to 8q, various patterns may be formed by the first group of protuberances 22a and the second group of protuberances 22b with the irregular arrangement.

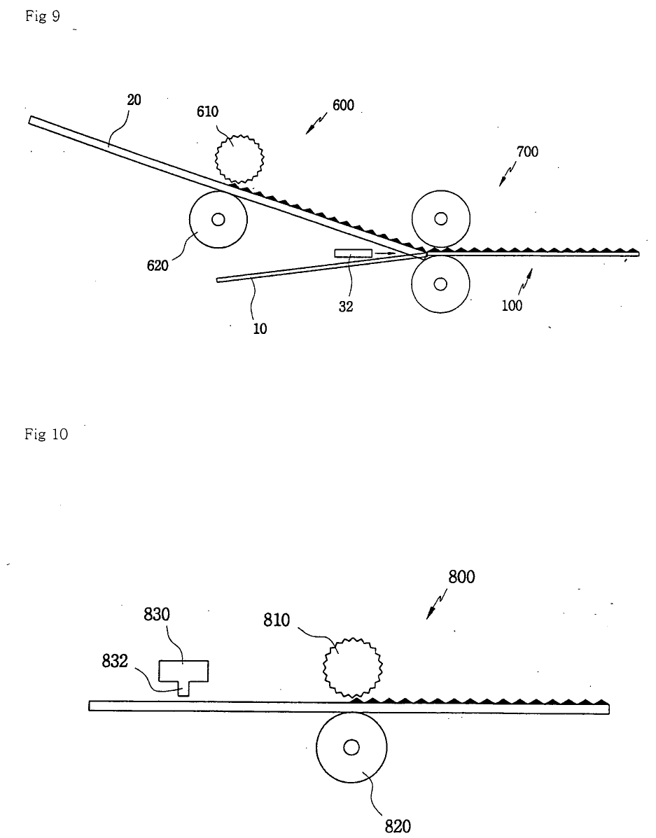

Below, a method of fabricating the vacuum packaging film is described, with reference to FIGS. 9 and 10.

A vacuum packaging film 100 of the present invention is manufactured according to a dry-laminating process or a T-die process.

FIG. 9 shows the dry-laminating process of manufacturing the packaging film 100. For this, a thermoforming layer 20 having first group of protuberances and second group of protuberances on an inner surface thereof is previously prepared as follows.

When the thermoforming layer 20 made of polyethylene is passed through a protuberance-forming unit 600 including a embossed roll 610 with embossments and a flat roll 620, protuberances 22 are formed on the inner surface of the thermoforming layer 20.

At this time, the embossed roll 610 of the protuberance-forming unit 600 has first group of embossments and second group of embossments. Thus, the thermoforming 20 is passed through the protuberance-forming unit 600, whereby first group of protuberances and second group of protuberances are formed on the inner surface of the resin layer 20, corresponding to each position of the first group of embossments and the second group of embossments of the embossed roll 610. Further, air passages are formed.

The first group of embossments and the second group of embossments of the embossed roll 610 have different arrangements arranged at different angles. Therefore, various patterns can be formed on a whole inner surface of the thermoforming layer 20.

The first group of embossments and the second group of embossments of the embossed roll 610 have various sizes, and, as well, various shapes like circle, triangle, rectangle, hexagon, octagon, star and etc.

Together with the previously prepared thermoforming layer 20 with two groups of protuberances, a base layer 10 made of an air-impermeable material is passed through a layering unit 700 with two layering rolls. As such, an adhesive 32 is introduced into the base layer 10 and the thermoforming layer 20. Thereby, the base layer 10 is adhered to the thermoforming layer with the two groups of protuberances, and an adhesive layer is intercalated into the base layer 10 and the thermoforming layer 20.

According to the dry-laminating process, the thickness of the base layer 10 and the thermoforming layer 20 is not limited, and thus the vacuum packaging film 100 having various thicknesses can be manufactured. Also, upon preparing the thermoforming layer 20 with two groups of protuberances, defective thermoforming layers are previously removed, whereby productivity of the vacuum packaging bag improves. However, since the adhesive 32 is expensive, manufacturing costs are relatively increased.

FIG. 10 shows the T-die process for use in the preparation of the vacuum packaging film. A thermoforming resin layer 20 is melt-extruded on a base layer 10 made of an air-impermeable material through a nozzle 832 of a T-die extruder 830, and then passed through a layering unit 800 with a embossed roll 810 having embossments and a water cooling roll 820, thereby obtaining a desired vacuum packaging film.

The embossed roll 810 of the layering unit 800 has first group of embossments and second group of embossments. Thus, the thermoforming layer 20 has first group of protuberances and second group of protuberances on the inner surface thereof, corresponding to each position of the first group of embossments and the second group of embossments of the embossed roll 810. Also, air passages are formed.

It is preferred that the first group of embossments and the second group of embossments of the embossed roll 810 have various sizes and various shapes like circle, triangle, rectangle, hexagon, octagon, star and etc.

As such, although the above vacuum packaging film mainly has two groups of protuberances, since a embossed roll having the maximum four groups of embossments can be manufactured for a T-die process, three groups of protuberances or four groups of protuberances can be formed on the vacuum packaging film.

In such a case, it is preferred that three groups of protuberances or four groups of protuberances have different arrangements arranged at different angles. For example, the first group of protuberances are downwardly arranged at 45, the second group of protuberances being arranged downwards at 60, the third group of protuberances being arranged horizontally at 0, and the fourth group of protuberances being arranged vertically at 90. Thus, the first group of protuberances, the second group of protuberances, the third group of protuberances and the fourth group of protuberances are arranged at different angles, whereby the pattern can be three-dimensionally formed on the inner surface of the vacuum packaging film, and be clearly viewed.

Therefore, the vacuum packaging film having three groups of protuberances or four groups of protuberances can have finer patterns, compared to vacuum packaging films having two groups of protuberances. Further, a total surface area of the protuberances exposed to the air is enlarged, thus improving a vacuum performance.

Further, on an outer surface of the thermoforming layer of the vacuum packaging film having two groups of protuberances, three groups of protuberances or four groups of protuberances, a layer printed with a pattern identical to that formed on the inner surface of the heat-sealing layer is transcribed, resulting in a clear display of the pattern formed on the inner surface thereof.

As described above, the present invention provides a vacuum packaging film, a manufacturing method thereof and a vacuum packaging bag using the same. In particular, the vacuum packaging film has two to four groups of protuberances, whereby a total surface area of the protuberances becomes wider and an output flux of air increases. Thus, an internal chamber of the vacuum packaging bag can be easily made to the state of vacuum. Further, various patterns can be formed by various sizes and different arrangement directions of the protuberances, therefore increasing the productivity of end products according to the needs of the users.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A vacuum packaging film, comprising:
a base layer; and
a thermoforming layer laminated on the base layer and having protuberances on an inner surface of the thermoforming layer to form air passages,
wherein the protuberances have first group of protuberances, and second group of protuberances having a height higher than that of the first group of protuberances.

2. The vacuum packaging film as defined in claim 1, wherein the first group of protuberances and the second group of protuberances have different arrangements arranged at different angles, to clearly show a pattern formed on the inner surface of the thermoforming layer.

3. The vacuum packaging film as defined in claim 2, wherein the first group of protuberances and the second group of protuberances have various sizes.

4. The vacuum packaging film as defined in claim 2, wherein the first group of protuberances and the second group of protuberances have different shapes.

5. The vacuum packaging film as defined in claim 2, wherein the patterns comprise a fruit shape.

6. The vacuum packaging film as defined in claim 2, wherein the patterns comprise an animal shape.

7. The vacuum packaging film as defined in claim 2, wherein the patterns comprise a character shape.

8. The vacuum packaging film as defined in claim 2, wherein the patterns comprise a plant shape.

9. The vacuum packaging film as defined in claim 2, wherein the patterns comprise a diagram shape.

10. The vacuum packaging film as defined in claim 1, wherein the first group of protuberances each are 0.8-1.5 times thicker than a thickness of the thermoforming layer.

11. The vacuum packaging film as defined in claim 1, wherein the second group of protuberances each are 1.0-2.0 times thicker than a thickness of the thermoforming layer.

12. The vacuum packaging film as defined in claim 1, further comprising an adhesive layer between the base layer and the thermoforming layer.

13. The vacuum packaging film as defined in claim 1, wherein the base layer comprises polyamide, polyester, or ethylene vinyl alcohol.

14. The vacuum packaging film as defined in claim 13, wherein the base layer comprises a multi-layered structure including at least one layer.

15. The vacuum packaging film as defined in claim 1, wherein the thermoforming layer comprises polyethylene.

16. The vacuum packaging film as defined in claim 1, wherein a surface of the thermoforming layer comprises a flat part which is not embossed, first group of protuberances, and second group of protuberances.

17. The vacuum packaging film as defined in claim 1, wherein a surface of the thermoforming layer comprises first group of protuberances and second group of protuberances.

18. The vacuum packaging film as defined in claim 1, wherein the protuberances further comprise third group of protuberances having a height higher than that of the second group of protuberances.

19. The vacuum packaging film as defined in claim 18, wherein the protuberances further comprise fourth group of protuberances having a height higher than that of the third group of protuberances.

20. The vacuum packaging film as defined in claim 18, wherein the first group of protuberances, the second group of protuberances and the third group of protuberances have different arrangements arranged at different angles, to clearly show a pattern formed on the inner surface of the thermoforming layer.

21. The vacuum packaging film as defined in claim 18, wherein the first group of protuberances, the second group of protuberances and the third group of protuberances have various sizes.

22. The vacuum packaging film as defined in claim 18, wherein the first group of protuberances, the second group of protuberances and the third group of protuberances have different shapes.

23. The vacuum packaging film as defined in claim 19, wherein the first group of protuberances, the second group of protuberances, the third group of protuberances and the fourth group of protuberances have different arrangements arranged at different angles, to clearly show a pattern formed on the inner surface of the thermoforming layer.

24. The vacuum packaging film as defined in claim 19, wherein the first group of protuberances, the second group of protuberances, the third group of protuberances and the fourth group of protuberances have various sizes.

25. The vacuum packaging film as defined in claim 19, wherein the first group of protuberances, the second group of protuberances, the third group of protuberances and the fourth group of protuberances have different shapes

26. The thermoforming film as claimed in claim 2, wherein a layer printed with a pattern identical to that formed on the inner surface of the thermoforming layer is transcribed to an outer surface of the thermoforming layer.

27. A vacuum packaging bag, comprising an upper sheet and a lower sheet superimposed mutually, in which lower edges and both side edges of the upper sheet and the lower sheet are sealed to form an inner chamber of the vacuum packaging bag, and upper edges of the upper sheet and the lower sheet are open to form an open part to receive contents into the vacuum packaging bag,
wherein at least one of the upper sheet and the lower sheet comprises the vacuum packaging film according to claim 1.

28. A method of manufacturing a vacuum packaging film, comprising the following steps of:
melt-extruding a thermoforming layer on a base layer made of an air-impermeable material through a nozzle of a T-die extruder, to prepare a film and
passing the film through a layering unit with a embossed roll having embossments and a cooling roll,
wherein the embossed roll of the layering unit has first group of embossments and second group of embossments, and thus the thermoforming layer has first group of protuberances and second group of protuberances on an inner surface thereof, corresponding to each position of the first group of embossments and the second group of embossments of the embossed roll, to form air passages.

29. A method of manufacturing a vacuum packaging film, comprising the following steps of:
passing a thermoforming layer through a protuberance-forming unit with a embossed roll having embossments and a flat roll, to form protuberances on an inner surface of the thermoforming layer and
passing a base layer made of an air-impermeable material and the thermoforming layer with the protuberances through a layering unit with two layering rolls,
wherein the embossed roll of the protuberance-forming unit has first group of embossments and second group of embossments, whereby the thermoforming layer passed through the protuberance-forming unit has first group of protuberances and second group of protuberances on an inner surface thereof, corresponding to each position of the first group of embossments and the second group of embossments of the embossed roll, to form air passages.

30. The method as defined in claim 28, wherein the first group of embossments and the second group of embossments of the embossed roll have different arrangements arranged at different angles, to clearly show a pattern formed on the inner surface of the thermoforming layer.

31. The method as defined in claim 28, wherein the first group of embossments and the second group of embossments of the embossed roll have various sizes.

32. The method as defined in claim 28, wherein the first group of embossments and the second group of embossments of the embossed roll have different shapes.
